(19) United States
(12) Patent Application Publication
(10) Pub. No.: US 2024/0184842 A1
(43) Pub. Date: Jun. 6, 2024

(54) QUANTUM-INSPIRED OPTIMIZATION OVER PERMUTATION GROUPS

(71) Applicant: Ford Global Technologies, LLC, Dearborn, MI (US)

(72) Inventors: Joydip Ghosh, Farmington Hills, MI (US); Rathi Munukur, San Jose, CA (US); Bhaskar Roy Bardhan, Hillsboro, OR (US)

(73) Assignee: Ford Global Technologies, LLC, Dearborn, MI (US)

(21) Appl. No.: 18/061,543

(22) Filed: Dec. 5, 2022

(51) Int. Cl. G06F 17/11

(52) U.S. Cl. CPC G06F 17/11

(57) ABSTRACT

A system and method to enhance computational efficiency includes generating a set of random replicas for a permutation-based optimization problem having an objective function representing only an original unconstrained objective, wherein each replica is an array of n symbols; defining a neighborhood for each replica within the domain of the objective function; and iteratively performing steps of an optimization algorithm (e.g., a Quantum-Inspired Optimization technique) to: perform local operations with probabilistic (e.g., Metropolis) acceptance criterion to transform a first replica to second replica within a neighborhood of the first replica; compare a least cost of second replica to a previously stored overall minimum cost; store the second replica as new overall minimum cost when the least cost is less than the previously stored overall minimum cost; and perform a next iteration until a convergence or a maximum number of iterations is achieved.

### BACKGROUND

Quantum-inspired optimization (QIO) algorithms are computational techniques that emulate certain quantum mechanical effects on standard computer hardware to tackle a class of optimization tasks. QIO methods have so far been employed to solve various binary optimization problems and a significant (polynomial) computational speedup over traditional techniques has also been reported. However, QIO methods do not work with an arbitrary optimization problem, where the domain of the underlying cost function is defined over a permutation group. Such problems are not naturally reducible to a binary optimization in general, and, therefore, are not necessarily within the scope of traditional QIO methods.

### BRIEF DESCRIPTION OF THE DRAWINGS

FIG. 1 is an example process flow for Quantum-Inspired Optimization over

permutations using Parallel Tempering.

FIG. 2 is an example process flow for Durstenfeld's implementation of the Fisher-Yates algorithm to generate random permutations.

FIG. 3A illustrates an example of a variable flipping operation.

FIG. 3B illustrates an example of an adjacent transposition for a consecutive pair within a permutation array.

FIG. 4 illustrates an example local operation within a Traveling Salesman Problem.

FIG. 5A is a graph illustrating an average number of queries of Perm-PA versus an exact solution over a number of stops n for an Energy-optimal Single-vehicle Parcel Delivery Problem.

FIG. 5B is a graph illustrating an average number of queries of Perm-SSMC versus an exact solution over a number of stops n for an Energy-optimal Single-vehicle Parcel Delivery Problem.

FIG. 5C is a graph illustrating an average number of queries of Perm-PT versus an exact solution over a number of stops n for an Energy-optimal Single-vehicle Parcel Delivery Problem.

FIG. 6 is an example diagram of a vehicular delivery system.

FIG. 7 is an example flow diagram of an implementation of QIO over permutation groups for a vehicular delivery system.

### DETAILED DESCRIPTION

Quantum-inspired optimization (QIO) refers to a family of algorithms that emulates some quantum phenomena on standard computer hardware to tackle global optimization problems more efficiently than traditional optimization techniques. The underlying objective function corresponding to an arbitrary non-trivial global optimization consists of many local minima often separated by tall and thin barriers. The performance of a global optimization solver, therefore, depends on how quickly it can hop out of such local optima to explore the global landscape. The time required to cross a barrier, however, scales exponentially with the barrier height for many traditional optimization methods, such as simulated annealing. QIO offers a solution to this challenge by emulating quantum effects, such as tunneling, which enables the QIO solver to sweep through the barriers as opposed to the computationally expensive thermal jumps exercised by simulated annealing.

A number of techniques can be characterized as members of QIO family. A Parallel Tempering (PT) technique is a generalization of a simulated annealing algorithm with multiple replicas (i.e., trial solutions) maintained at different temperatures. As used herein, the temperature is a parameter that affects the probability of accepting a trial point with higher objective function value. Two neighboring (in the temperature space) replicas are exchanged periodically following a protocol. A Population Annealing (PA) technique is a generalization of simulated annealing with multiple walkers maintained at a specific temperature. The population of walkers are resampled as temperature gets lowered, eventually collapsing to a low-cost state. A Substochastic Monte Carlo (SSMC) technique is an emulation of quantum annealing via the diffusion of population of walkers across the landscape of the objective function. Walkers get removed or created according to a protocol.

These QIO techniques have so far been used to tackle binary optimization problems with an underlying objective function f: {0, 1}ⁿ→ [symbol] , where n is the number of binary variables. It is, in principle, possible to solve a broad class of discrete and combinatorial optimization problems using these QIO techniques, once the problems are reformulated as unconstrained binary optimization tasks. This reformulation process usually introduces significant complexity to the problem due to some additional constraints that need to be satisfied.

A class of combinatorial optimization problems that is of interest in the present disclosure is optimization over a permutation group, where the domain of the underlying objective function is a set of permutations. A large number of computational problems, such as a quadratic assignment problem, a linear ordering problem, a job-shop scheduling problem, and a traveling salesman problem (TSP), belong to this category. Due to the combinatorial nature of the decision variables, not only are these problems non-deterministic polynomial-time (NP)-hard in general, but also approximation methods do not even exist for many of them. Optimization problems over a space of permutations, therefore, rely on metaheuristic approaches, such as QIO and evolutionary algorithms, as potential solvers for practical purposes. It should be noted that, for the purpose of the present disclosure, optimization problems are distinguished from search problems. While it is in principle possible to leverage searching algorithms, such as Tabu or guided local search, to tackle optimization problems, the present disclosure assumes that there exists some structure in the landscape of the objective function of an arbitrary (non-convex) optimization task that global optimization algorithms can leverage in order to find a good minimum more efficiently using less number of queries.

The traditional implementation of QIO, when employed to tackle a permutation-based optimization, first maps the space of permutations to a space of binary permutation matrices and then imposes additional constraints to ensure that any optimal solution is valid and the resulting binary matrix can be mapped back to a well-defined permutation. Not only does this process consume a substantial amount of computational resources, but it often fails to guarantee the validity of the output as a legitimate permutation for heuristic solvers, due to its extreme sensitivity on the penalty coefficients for the imposed constraint terms. Moreover, there exists a class of optimization problems over a set of permutations where the cost of a given permutation depends on the entire sequence of symbols for that permutation itself, and therefore cannot be reduced to a sum of the products of elements between cost and the permutation matrices. These problems are not even readily amenable to a binary reformulation and are thus beyond the scope of traditional implementation of QIO.

In accordance with the present disclosure, an algorithmic technique for Quantum-Inspired Optimization over permutations, herein referred to as Perm-QIO, has been developed to enable existing QIO techniques (except for the ones based on cluster updates), such as Parallel Tempering (PT), Population Annealing (PA), and Substochastic Monte Carlo (SSMC), to directly tackle any optimization over permutations without resorting to a reformulation. Perm-QIO can enhance the efficiency of computational resources by reducing the cycles/processing time required to solve optimization problems on standard computer hardware. In an implementation, Perm-QIO can enhance delivery vehicle efficiency.

In one or more implementations of the present disclosure, a system includes a computer having a processor and a memory, the memory storing instructions executable by the processor programmed to: generate a set of random replicas for a permutation-based optimization problem having an objective function representing only an original unconstrained objective, wherein each replica is a sequence of n symbols; define a neighborhood for each replica within a domain of the objective function; and iteratively perform steps of an optimization algorithm to: perform local operations with probabilistic acceptance criterion to transform a first replica to a second replica within a neighborhood of the first replica; compare a least cost of the second replica to a previously stored overall minimum cost; store the second replica as new overall minimum cost when the least cost of the second replica is less than the previously stored overall minimum cost; and perform a next iteration until a convergence or a maximum number of iterations is achieved.

In an implementation, the instructions to generate the set of random replicas may include instructions to generate the replicas sampled from a uniform distribution of permutations.

In another implementation, the instructions to generate the set of random replicas may use Durstenfeld's implementation for a Fisher-Yates algorithm.

In yet another implementation, the local operations may include a transposition of an adjacent pair of symbols.

In an implementation, the adjacent pair of symbols may be selected randomly.

In another implementation, the optimizing algorithm may be a Quantum-Inspired Optimization technique including Parallel Tempering.

In an implementation, the system may further include instructions to: initialize a temperature space from Tₘᵢₙ to Tₘₐₓ in accordance with a profile function with Tₙᵤₘ distinct temperatures; initialize a random replica for each temperature in the temperature space; initialize an overall minimum cost to infinity; and initialize an iteration number to 0, wherein each iteration further includes instructions to swap random neighboring replicas.

In another implementation, the probabilistic acceptance criterion may be a Metropolis acceptance criterion, and the instructions to iteratively swap random neighboring replicas may swap random neighboring replicas with Metropolis acceptance criterion.

In yet another implementation, the optimizing algorithm may be a Quantum-Inspired Optimization technique including Population Annealing.

In a further implementation, the optimizing algorithm may be a Quantum-Inspired Optimization technique including Substochastic Monte Carlo.

In one or more implementations of the present disclosure, a method may include generating a set of random replicas for a permutation-based optimization problem having an objective function representing only an original unconstrained objective, wherein each replica is a sequence of n symbols; defining a neighborhood for each replica within a domain of the objective function; and iteratively performing steps of an optimization algorithm to: perform local operations with probabilistic acceptance criterion to transform a first replica to second replica within a neighborhood of the first replica; compare a least cost of second replica to a previously stored overall minimum cost; store the second replica as new overall minimum cost when the least cost is less than the previously stored overall minimum cost; and perform a next iteration until a convergence or a maximum number of iterations is achieved.

In an implementation, generating the set of random replicas may include generating the replicas sampled from a uniform distribution of permutations.

In another implementation, generating the set of random replicas may use Durstenfeld's implementation for a Fisher-Yates algorithm.

In yet another implementation, the local operations may include an adjacent transposition of an adjacent pair of symbols.

In an implementation, the adjacent pair of symbols may be selected randomly.

In another implementation, the optimizing algorithm may be a Quantum-Inspired Optimization technique including Parallel Tempering.

In yet another implementation, the method may further include: initializing a temperature space from Tₘᵢₙ to Tₘₐₓ in accordance with a profile function with Tₙᵤₘ distinct temperatures; initializing a random replica for each temperature in the temperature space; initializing an overall minimum cost to infinity; and initializing an iteration number to 0, wherein each iteration further includes an operation to swap random neighboring replicas.

In an implementation, the probabilistic acceptance criterion of the method may be a Metropolis acceptance criterion, and the operation to swap random neighboring replicas may swap random neighboring replicas with Metropolis acceptance criterion.

In another implementation, the optimizing algorithm may be a Quantum-Inspired Optimization technique including Population Annealing.

In yet another implementation, the optimizing algorithm may be a Quantum-Inspired Optimization technique including Substochastic Monte Carlo.

Implementations of Perm-QIO are described below with respect to the traveling salesman problem (TSP) and a vehicle routing problem, where one needs to find the specific optimal sequence of n drop-off locations for a vehicle filled with n parcels (each having different weights), such that the total energy consumption of the vehicle is minimum. The energy usage of the vehicle between two consecutive stops depends also on the total weight of the parcels carried, which varies along the route as the parcels get dropped off. This problem offers a non-trivial generalization of TSP, which cannot be formulated as a binary optimization and, therefore, is not amenable to traditional implementation of QIO techniques.

In general, an optimization problem may be defined as follows: Given an objective function f: X→ [symbol] , find xₘᵢₙ∈X, s.t., f(xₘᵢₙ)≤f(x)∀x∈X . In the case of an optimization over permutations, X⊆Sₙ for some n∈N, where Sₙ is the set of all permutations of the ordered symbols {1, 2, . . . , n}. Since |Sₙ|=n!, the optimization over permutations gets intractable for brute force methods as the number of symbols grow polynomially. Sₙ forms a group (called the symmetric group) under composition of two permutations, with the following (non-exhaustive) generating sets:
1. Sₙ can be generated by the transpositions (1, 2), (1, 3), . . . , (1, n).
2. Sₙ can be generated by the transpositions of adjacent symbols (1, 2), (2, 3), . . . , (n−1, n).

It is possible to cast a permutation-based optimization as a 0/1-integer programming in order to use existing solvers based on traditional methods, such as branch-and-bound, cutting-planes or dynamic programming. The first step towards this approach is to represent an arbitrary permutation σ∈S, as a binary permutation matrix Π^{σ}, such that,

$${\prod }_{ij}^{σ} = \{ \begin{matrix}1 , & if σ ( i ) = j , where i , j ∈ \{ 1 , 2 , … , n \} \\ 0 , & otherwise\end{matrix} .$$

A class of optimization problems over permutations can be formulated as a 0/1-integer programming:

$${min}_{{x}_{ij} ∈ \{ 0 , 1 \}} {\sum }_{ij} f ( {x}_{ij} ) , \qquad ( 1 )$$

$$subject to : {\sum }_{i} {x}_{ij} = 1 ∀ j ∈ \{ 1 , 2 , … , n \} ,$$

$${\sum }_{j} {x}_{ij} = 1 ∀ i ∈ \{ 1 , 2 , … , n \} ,$$

where the matrix [xᵢⱼ] is not block-diagonal and fis the cost function for a given permutation. The constraints enforce that the matrix [xᵢⱼ] is a valid adjacency matrix. The constraints remain same for all permutation-based optimization problems, whereas the cost function f varies. For example, f(xᵢⱼ)=cᵢⱼxᵢⱼ for TSP, where cᵢⱼ is the cost associated with the edge connecting i^{th} and j^{th} vertices. For another class of problems, the costs cᵢⱼ depend non-trivially on the matrix [xᵢⱼ] only if [xᵢⱼ] corresponds to a valid permutation and not well-defined otherwise. This precludes the construction of a cost function in closed form for an invalid (binary) permutation matrix for this class of problems making them incompatible with the requirements for a 0/1-integerprogramming. In order to solve permutation-based optimization problems using unconstrained optimization methods, such as QIO, the constraints in formulation (1) need to be baked into the objective function as,

$${min}_{{x}_{ij} ∈ \{ 0 , 1 \}} J ( x ) = {\sum }_{i , j} f ( {x}_{ij} ) + {w}_{1} {\sum }_{j} {( {\sum }_{i} {x}_{ij} - 1 )}^{2} + {w}_{2} {\sum }_{i} {( {\sum }_{j} {x}_{ij} - 1 )}^{2} , \qquad ( 2 )$$

subject to the constraint that the matrix [xᵢⱼ] is not block-diagonal. Here w₁ and w₂ are penalty coefficients required to convert the constrained optimization (1) to an unconstrained one. While such a reduction may not exist for a class of permutation-based optimization as discussed, even when it does, it introduces two additional complexities to this approach:
1. No heuristic solvers guarantee that the obtained optimal binary matrix is also a valid permutation matrix, unless the solver finds the global minimum.
2. For n symbols, the size of the domain changes from n! to 2ⁿ⁽ⁿ⁻¹⁾, and the latter scales O(2ⁿ) times faster than the former. So the reformulation indeed offers an exponentially larger space to search for the global optima.

Based on these observations, the present disclosure addresses adapting QIO techniques directly to the space of permutations. Various QIO techniques have been used to tackle hard binary optimizations problems and are discussed below.

The replica exchange Monte Carlo (referred herein as Parallel Tempering) algorithm has been used to overcome the barriers on rough landscapes by simulating a number of replicas maintained at different temperatures. In the present context, temperatures are essentially hyper-parameters for an optimization problem whose values are chosen. The Parallel Tempering (PT) algorithm can be thought of as a generalization of the simulated annealing, where M non-interacting replicas (trial solutions) of the system are simulated simultaneously at temperatures T₁, T₂, . . . T_{M}. After performing a fixed number of Monte Carlo sweeps (Metropolis updates), two replicas at neighboring temperatures are swapped with each other. This swap between the replicas is subject to an acceptance probability given by,

p(Eᵢ, Tᵢ→Eᵢ₊₁, Tᵢ₊₁)=min{1, exp(ΔβΔE)}, (3)

where Δβ=1/Tᵢ+1−1/Tᵢ is the difference between the inverse temperatures of the replicas and ΔE=Eᵢ+1−Eᵢ is the difference in energy of the two replicas at those temperatures. This probability satisfies the detailed balance conditions so that the algorithm converges to the equilibrium Gibbs distribution for each temperature. An outline of the PT algorithm, as applied to a system consisting of binary variables in an optimization problem, is given below:
1. Initialize: Initialize the replicas X₁, X₂, . . . Xₘ of the system at temperatures T₁, T₂, . . . Tₘ, where temperatures are in descending order.
2. Sweep: On each replica Xⱼ, perform n flips of the variables randomly. Such flips are done by randomly selecting a site, proposing a flip for the binary variable therein, accepting (or rejecting) the proposal as per a probabilistic acceptance criterion (e.g., Metropolis-Hastings acceptance criteria) and finally repeating it n times.
3. Swap: Swap m−1 number of replicas that are adjacent to each other in the temperature space subject to the acceptance probability given by equation (3).
4. Repeat: Repeat the steps 2 and 3 above until some termination criterion is met based on convergence or maximum number of iterations.

For a given replica at a specific temperature, a random walk in the temperature space is induced by the swap move. Optimal performance of the PT algorithm in this space depends on how the temperatures of the replicas are distributed. Two commonly used temperature profiles include geometric and inverse linear temperature profiles. Under the geometric temperature profile, the i^{th} temperature Tᵢ is given by,

$${T}_{i} = {{T}_{1} ( {T}_{m} / {T}_{1} )}^{\frac{i - 1}{m - 1}} . \qquad ( 4 )$$

Under the inverse-linear scheme, the i^{th} inverse temperature is:

$${β}_{i} = {β}_{m} + ( {\dot{β}}_{1} - {β}_{m} ) \frac{i - 1}{m - 1} . \qquad ( 5 )$$

Other approaches, such as energy-based methods and feedback-optimized techniques, have also been proposed to set the temperatures for parallel tempering that can boost the performance of PT for many instances. Unless stated otherwise, the present disclosure uses geometric spacing as the temperature profile for implementing PT.

The Population Annealing (PA) technique can be thought of as a combination of the simulated annealing with a differential reproduction of the replicas. In a way very similar to simulated annealing, the temperature of the system is systematically lowered through a sequence of temperatures. However, unlike simulated annealing, at each temperature a population of replicas is resampled in order for the replicas to stay close to the equilibrium ensemble Gibbs distribution at that temperature. After this resampling, Monte Carlo sweeps on each replica are performed. If the original higher temperature population starts in an equilibrium ensemble in the Gibbs distribution at the inverse temperature, then the resampling process ensures the final population is also an equilibrium ensemble at the lower temperature at the end of the simulation. The steps involved in the population annealing are outlined below:
1. Initialize: Start with a population of R independent replicas of the system in the uniform distribution at inverse temperature β₀.
2. Resampling: To create an approximately equilibrated sample at βi>βi−1, resample replicas with their relative Boltzmann weights

$${τ}_{i} ( {E}_{j} ) = exp [ - ( β i - {β}_{i - 1} ) {E}_{j} ] / {Q}_{j} . \qquad ( 6 )$$

$$where {Q}_{i} = \frac{1}{{R}_{i - 1}} {\sum }_{j = 1}^{{R}_{i - 1}} exp [ - ( {β}_{i} - {β}_{i - 1} ) {E}_{k} ] . \qquad ( 7 )$$

Here Eⱼ denotes the energy of the j-th replica and Rₖ denotes the population size for the kth iteration (corresponding to the temperature βₖ).
For each replica j in the population at inverse temperature βᵢ−1, draw a random number r uniformly in [0,1).
In the new population, the number of copies in the j-th replica is then taken to be

$${r}_{i}^{j} = \{ \begin{matrix}⌊ \hat{{τ}_{i}} ( {E}_{j} ) ⌋ & if r > \hat{{τ}_{i}} ( {E}_{j} ) - ⌊ \hat{{τ}_{i}} ( {E}_{j} ) ⌋ \\ \hat{{τ}_{i}} ( {E}_{j} ) ⌋ + 1 & otherwise\end{matrix} , \qquad ( 8 )$$

where └. . . ┘ denotes the Hoor function and fᵢ(Eⱼ)=(R/Rᵢ)τᵢ(Eⱼ) is normalized to keep the population size close to R. The above choice of the number of copies rᵢ^{j} ensures that the mean of the random, non-negative integer rᵢ^{j} is \hat{τ}ᵢ(Eⱼ) with its variance minimized and proportional to \sqrt{R}.
Calculate the new population size

$${R}_{i} = {\sum }_{j} {r}_{i}^{j} \qquad ( 9 )$$

3. Perform Metropolis updates: Update each replica by Nₛ rounds of MCMC sweeps (Metropolis updates) at inverse temperature βi.
4. Evaluate energy cost: Estimate energies as population averages

$$\overline{e} = \frac{1}{{R}_{i}} {\sum }_{j} {E}_{j} / N , \qquad ( 10 )$$

where N is the number of the binary variables.
5. Repeat: Continue until final temperature β_{f} is reached.

Population annealing has shown to be an efficient algorithm for simulating spin glasses. In general, it serves as a method suitable for simulating the equilibrium states of systems with rough energy landscapes, providing comparable performance as the parallel tempering.

Substochastic Monte Carlo (SSMC) is a diffusion Monte Carlo algorithm that is tailored to simulate stochastic adiabatic processes. This algorithm is inspired by adiabatic quantum computation and can be used to simulate the diffusion of walkers in the search space. The SSMC algorithm can be thought as a combination of this diffusion and resampling at each time step where the walkers are either eliminated or duplicated depending on how these walkers perform according to the cost function of a given optimization problem. The final distribution of the walkers, after running the algorithm for a specific optimization problem, will be proportional to the final ground state. In this sense, SSMC algorithm can be considered as a method for solving optimization problems. As a classical optimization algorithm, SSMC performs competitively with respect to other heuristic classical solvers for MAX-k-SAT problem at k=2, 3, 4.

In the following, the use of SSMC method is described for finding the ground state of an arbitrary Hamiltonian defined on a set of binary variables. This approach can be naturally extended to solve an arbitrary binary optimization problem, where the Hamiltonian gets replaced by a cost function. Consider a family of stochastic Hamiltonians H(s) which is parameterized by a schedule s, representing an adiabatic process, where the parameter s(t) is varied from 0 to 1. The corresponding imaginary-time dynamics represents a continuous-time diffusion process or random walk of a set of walkers, where walkers can die. The following equation captures this diffusion process

$$\frac{d}{dt} ψ = - H ( s ( t ) ) ψ . \qquad ( 11 )$$

The discretized time-evolution in this case is a substochastic Markov chain and the corresponding time evolution operator e^{-H(s)Δt} is a substochastic matrix when sufficiently small time steps Δt are considered with respect to the gap between the ground and the first excited states. In this substochastic process, the total probability decreases as some walkers die.

For a given cost function associated with an optimization problem, the Hamiltonian H(s) is written as

H(s)=a(s)L+b(s)W, (12)

where the cost function is represented by the diagonal operator W=diag(w₁, w₂, . . . ), L is the graph Laplacian, and a(s), b(s) are two monotonically decreasing and increasing functions over s∈[0, 1], respectively, which determines how the Hamiltonian is being swept from L to W. Initially, when s is small, this Hamiltonian is dominated by L and the walkers widely explore the search space. However, as s becomes larger, the Hamiltonian H(s) is dominated by the cost function when the walkers start to become more concentrated in the search space region where the minima of the problem are likely to be found.

How to compute the probabilities of each of the random transitions the walkers can go through for a given binary optimization problem is now illustrated. Let a graph G=(V, E) represent this optimization problem where V and E denote the vertex and edge sets, respectively. The combinatorial Laplacian corresponding to this graph is denoted by L=D−A, where D is the diagonal operator for the degrees o the vertices and A is the adjacency matrix of the graph. If the given problem has n binary variables, it can be represented on a n-dimensional hypercube with 2n vertices, where the vertices represent the possible states of the variables and the edges are formed only if the connecting vertices differ by a single bit.

A given walker in this random walk process can go through any of the random transitions on this hypercube: step, stay, die or spawn a new walker. The probability of dying or spawning a new walker is determined by the cost function while the probabilities for stepping or staying are provided by the underlying Markovian dynamics of the process. This is shown by computing the probabilities of these transitions in the outline of the SSMC algorithms as illustrated below:
1. Initialize: Initialize the walkers in the ground state of H(s=0), which is typically the uniform distribution.
2. Execute Markov chain: As s is increased from 0 to 1, execute the Markov chain Πⱼ1−H(s(tⱼ))Δtⱼ where Δtⱼ is the j-th time step size and tⱼ=Σₖ₌₁^{j}Δtⱼ.
3. Perform random transitions: At time t, compute the value s=s(t) according to a schedule, and a walker on the j-th vertex of the hypercube will do one of the following:
   A. Step to a neighboring vertex with probability a(s)Δtdⱼ, where dⱼ is the degree of the j-th vertex.
   B. Stay at the j-th vertex with probability 1−a(s)Δtdⱼ−|b(s)Δt(wⱼ− [symbol] W [symbol] ₜ)|, where [symbol] W [symbol] t is the population mean computed with respect to the current population of the walkers at time t.
   C. If b(s)Δt(wⱼ− [symbol] W [symbol] ₜ)>0, the walker dies with this probability.
   D. If b(s)Δt(wⱼ− [symbol] W [symbol] ₜ)<0, then then the walker spawns a new one at the j-th vertex with probability b(s)Δt( [symbol] W [symbol] ₜ−wⱼ).
4. Repeat: Repeat the above steps until convergence in energy is achieved or there are no more walkers.

It is important to suitably replenish the population after each time step otherwise the process could terminate after a short amount of time. It has been shown that by setting an adaptive energy threshold, it is possible to replenish the population effectively. If the energy of the walker is above the energy threshold, it dies and if its energy lies below the threshold it spawns a new worker at its site. This replenishment strategy has been captured in the above outline of the algorithm. In addition, it is important to ensure that during the simulation, the population size remains close to a nominal value and it can be accomplished by adjusting the energy threshold [symbol] W [symbol] ₜ, specifically by selecting an energy offset E and replacing [symbol] w [symbol] ₜ by [symbol] W [symbol] ₜ−E.

The above choice of probabilities, in conjunction with the adaptive replenishment of the population of the walkers, ensures that the initial distribution remains close to the quasistationary distribution which is proportional to the ground state of the original Hamiltonian. The optimum solution is found when at least one of the walkers is found at the minimum energy vertex of the hypercube. The SSMC algorithm thus provides the ground state, or the lowest energy state as the solution of the binary optimization problem.

Perm-QIO and the application of QIO to Permutations will now be described.

It is observed that in order to solve an arbitrary optimization problem under traditional implementation of QIO tools, the following criteria are necessary (also sufficient for tools that do not require cluster updates):
1. Drawing an arbitrary number of replicas randomly from a uniform distribution:
   In the context of a discrete optimization, this criterion reduces to a random sampling (from uniform distribution) for each variable within its domain. In case the domains of all variables are same, such as when the variables are all integers within a fixed interval, one can satisfy this condition either by drawing a random number for each variable within its domain or by drawing a random instance from the domain of the objective function. As an example, consider an objective function (x₁, x₂, x₃), where 2≤xₖ≤8 for all k∈{1, 2, 3}. This criterion can be satisfied by generating a replica, where each xₖ is chosen randomly within [2, 8], or by choosing a random number between 222 and 888 and then assigning the kth digit of the number to the variable xₖ, ∀k∈{1, 2, 3}.
2. Performing local operations on a given replica to transform it to another replica that is adjacent to the original one:
   In the context of binary optimization, this criterion boils down to single variable updates—e.g., a single spin-flip for a Hamiltonian of a spin chain. One can adapt this criterion for an arbitrary discrete optimization, where a single variable needs to be updated by one of its two adjacent values. In any case, satisfying this criterion essentially means that QIO requires a concept of neighborhood that must be defined on the domain of the objective function for any replica. The elements of a specific neighborhood are nearest neighbors connected via local operations.

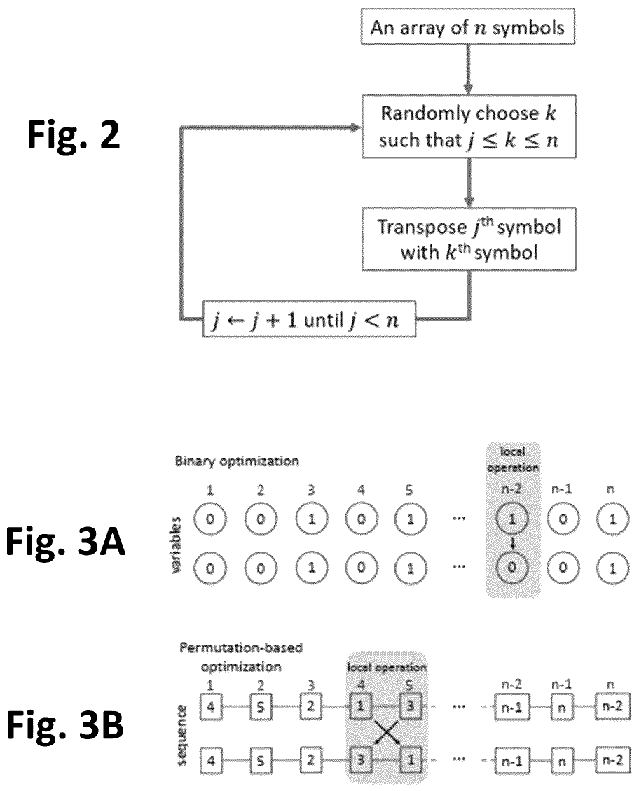

The primary challenge to overcome in order to extend QIO directly to permutation-based optimization problems is to systematically adapt these criteria for a space of permutations. Here, how Perm-QIO achieves this goal is described in FIG. 2.

FIG. 2 illustrates a flowchart for Durstenfeld's implementation for a Fisher-Yates algorithm to generate random permutations. Durstenfeld's implementation for the Fisher-Yates algorithm is used to generate random permutations, and starts with an array of n symbols (i.e. describing a replica). An integer k is chosen such that j≤k≤n, where j is an integer for a lower limit. In the array, the j^{th} symbol is then transposed with the kth symbol. Then, so long as j<n. j is then set to j+1 for the next iteration.

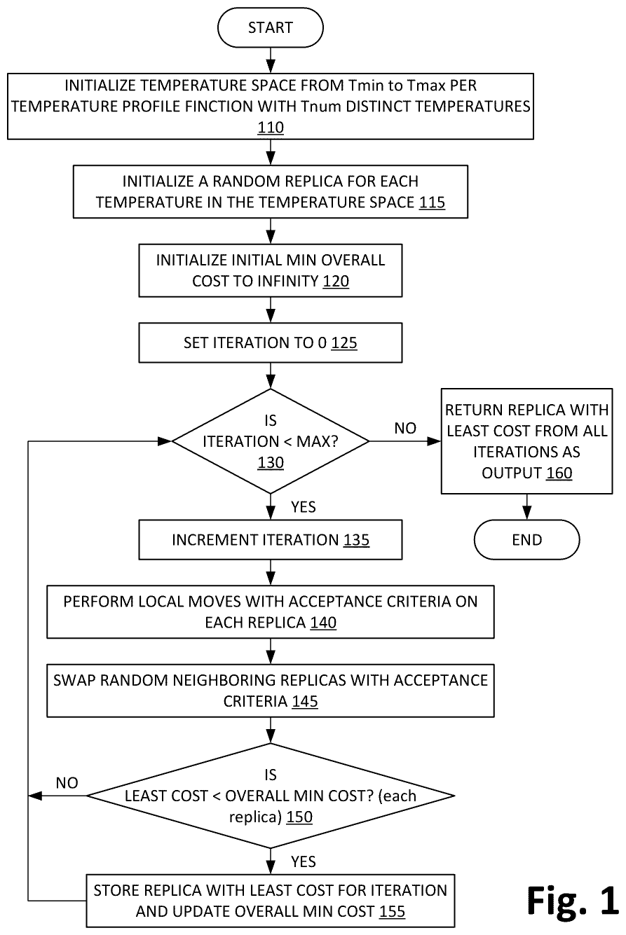

FIG. 1 illustrates an example flow process 100 of an implementation of Perm-QIO using Parallel Tempering.

In a first block 110, a computer initializes a temperature space from Tₘᵢₙ to Tₘₐₓ per a temperature profile function with Tₙᵤₘ distinct temperatures.

In a next block 115, the computer initializes a random replica for each temperature in the temperature space.

In a block 120, the computer initializes an initial minimum overall cost to infinity.

In a block 125, the computer sets an initial iteration (number) to 0 (zero). A maximum number of iterations may be determined based upon the number of random replicas.

In a decision block 130, the computer determines whether the iteration (number) is less than the maximum.

If the iteration (number) is less than the maximum at block 130 (i.e., “YES”), then at block 135, the computer increments the iteration (number).

At a block 140, the computer then performs local moves with Metropolis acceptance criteria on each replica. A local move may be a transposition of a random adjacent pair of symbols in a sequence (i.e., array) of a replica.

In a next block 145, the computer swaps random neighboring replicas with Metropolis acceptance criteria.

In a decision block 150, the computer determines if the least cost (of the cost-function) for each of the replicas is less than the overall minimum cost.

If the least cost for a replica is less than the overall minimum cost at block 150, the computer stores the replica with the least cost for the iteration and updates the overall minimum cost, and then returns to block 130.

If the least cost for a replica is not less than the overall minimum cost at block 150, the computer returns to block 130 for another iteration.

If, at block 130, the computer determines that the iteration (number) is not less than the maximum (i.e., “NO”), the computer returns the replica with the least cost (as stored at block 155) from all iterations as the output at block 160. The process 100 then ends.

FIG. 3A illustrates local operations for a generic binary optimization and FIG. 3B illustrates local operations for an optimization over permutation spaces. For a binary optimization it involves an update of a single variable selected randomly. For permutation-based optimization it involves an adjacent transposition for a consecutive pair selected randomly.

### Sampling from Random Permutations

Generating a set of random replicas for a permutation-based optimization reduces to generating random permutations for the sequence of symbols, which was first proposed by Fisher & Yates. An efficient implementation of Fisher-Yates algorithm is used, as shown in FIG. 1, to generate the replicas sampled from a uniform distribution of permutations. This step carries no additional computational overhead as the algorithm scales linearly with the number of symbols in the sequence and can be parallelized easily on multiple cores to generate multiple replicas simultaneously.

### Local Operations Over a Space of Permutations

QIO requires defining a neighborhood for each replica and also a local operation that transforms one replica to another within its neighborhood. Whereas the local operations are supposed to perturb a replica minimally, it is also imperative that the entire domain of the underlying objective function must be generated from an arbitrary replica via the composition of such local operations. For a binary optimization problem, the neighborhood of a given replica is defined as the set of replicas obtained by flipping a single variable. FIG. 2 shows how a local operation acts on an arbitrary replica for a binary optimization problem (upper panel) and also how to adapt it to an optimization over permutation groups replacing the single-variable update with an adjacent transposition (lower panel). It is important to note that an adjacent transposition does qualify for a local operation, as it is not only the minimal change that can be imposed on a sequence of symbols, but also is a generator of the symmetry group that consists of all possible permutations. If the domain of the objective function is viewed as a graph with each replica being a vertex that is only connected to its neighboring replicas via edges, it is a hypercube for an arbitrary binary optimization problem, where the dimension of the hypercube is the same as the number of variables. For optimization over permutations of a (non-cyclic) sequence, the graph is still isomorphic to a hypercube with dimension n−1, where n is the number of symbols in the sequence.

### Example: Traveling Salesman Problem

The optimization version of the Traveling Salesman Problem (TSP) can be stated as follows: Given a set of n points in a metric space (i.e., distance between every pair of points is known), find the shortest route that visits all the points exactly once and then returns to the starting point. The decision version of TSP is known to be NP-complete. In order to find the exact solution using brute-force, one needs to perform n! operations to find the shortest route in the worst case. Dynamic programming offers a time-complexity of O(n²2ⁿ) trading it off against a space-complexity of O(n2ⁿ). A number of approximations as well as heuristic algorithms, however, do exist to tackle TSP that can offer high-quality solutions more efficiently than exact algorithms.

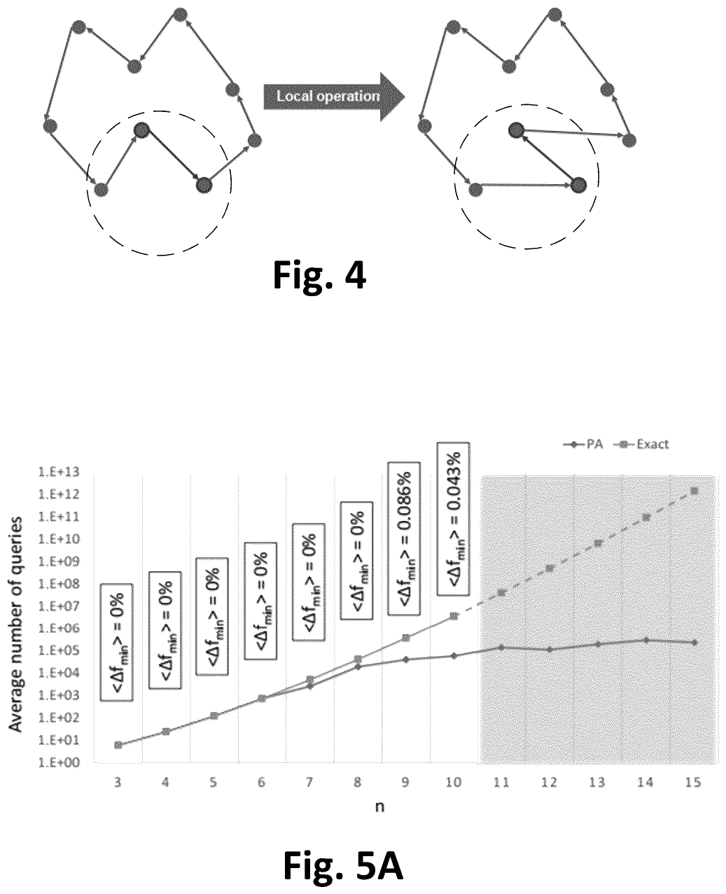

FIG. 4 illustrates a schematic diagram showing how an adjacent transposition transforms a given route for a TSP.

Here TSP is used as a candidate permutation-based optimization problem to describe Perm-QIO. The underlying objective function, under Perm-QIO formalism, is given by,

f_{TSP}(r)= [symbol] [r], (13)

where r∈R is a specific route and D: R→ [symbol] _{>0} denotes the mapping between the space of routes and the travel costs, such as the distance or time. With Perm-QIO. frsp in equation (13) can be directly optimized as long as there is: (i) an efficient algorithm to sample randomly from R that can be achieved by generating random sequences of points using Durstenfeld's algorithm as outlined in FIG. 1; and (ii) well-defined set of local operations for any r∈R, which can be achieved by performing an adjacent transposition on two neighboring points for a given route, as shown in FIG. 3. Assuming the starting point to be the fixed one, the neighborhood of a given route r with n points (excluding the starting point) consists of n−1 possible routes corresponding to n−1 adjacent transpositions.

### Application to Energy-Optimalvehicle Routing

In order to compare the performance of Perm-QIO over traditional implementation of QIO, a permutation-based optimization problem is needed that can serve as a benchmark. The present disclosure submits that any permutation-based optimization that is hard (i.e., their decision version being NP-hard) with respect to exact, approximation and heuristic solutions can serve the purpose of benchmarking Perm-QIO. TSP belongs to the class of permutation-based optimization problem and is NP-hard for exact solutions. However, there exist approximation and heuristic algorithms that can offer reasonably accurate solutions for TSP in polynomial time. Here, a constrained TSP is formulated, called Energy-optimal Single-vehicle Parcel Delivery Problem (ESPDP), for which the TSP heuristics cannot readily be employed to find the approximate solution. ESPDP is used herein to benchmark Perm-QIO against traditional QIO methods.

### ESPDP Formulation

ESPDP is an optimization problem, where one needs to find the optimal sequence of delivery stops for a vehicle under minimum energy consumption. The additional complexity with respect to TSP emerges from the fact that energy consumption here depends on the weight carried by the vehicle and as the vehicle drops the parcels its energy consumption gets lower. Therefore, unlike TSP, the cost to travel from the i^{th} stop to the j^{th} stop cannot be determined a priori for this case; it rather depends on the position of the route segment connecting the i^{th} and the j^{th} nodes in the entire route. Qualitatively speaking, the trade-off exists between dropping the heaviest parcel vs. serving the nearest or the farthest stop.

ESPDP satisfies the criteria for an optimization over a space of permutations, as the optimal solution exists in the set of permutation of stops. The objective function can be expressed as,

f_{ESPDP}(r)= [symbol] [r], (14)

where r∈R is a specific route and C: R→R_{>0} denotes the map between the set of all possible routes and the total energy consumption. As discussed earlier, C[r] here cannot be expressed as Σ_{i,j}Cᵢⱼ(rᵢⱼ), where Cᵢⱼ denotes some energy cost function for the route segment rᵢⱼ. C[r] must, therefore, be determined from a given route as,

$$C [ r ] = {\sum }_{{k = 0}_{n + 1 \to 0}}^{n} [ ( {W}_{v} + {\sum }_{k < j \leq u} {W}_{j} ) {C}_{k , k + 1} + {ρ}_{k , k + 1} ] \qquad ( 15 )$$

where the route r is defined via the sequence of stops {0, 1, 2, . . . , n, 0}, Wⱼ is the weight of the j^{th} parcel (to be delivered at the j^{th} stop), Wᵥ is the weight of the vehicle, ρ_{i,j} captures the contributions from air resistance and C_{i,j} is the proportionality coefficient connecting the weight of the vehicle to the fuel consumption cost for the given route segment. This considers a simplistic energy consumption model without any loss of generality, where the energy expenditure linearly depends on the weight of the vehicle. It should also be noted that, in absence of any fixed weight matrix, ESPDP (unlike TSP) cannot be readily formulated as a binary optimization problem.

### Results: Performance of Perm-QIO for ESPDP

In order to demonstrate the capabilities of Perm-QIO, arbitrary instances of ESPDP are generated for each n, where n denotes the number of stops. Next three different Perm-QIO techniques are applied: Perm-PA, Perm-SSMC and Perm-PT, which are essentially the adapted versions of PA, PT and SSMC algorithms for the permutation problems. These tools are applied on each problem instance for every n and record the number of times the cost function is evaluated (or queried) by these algorithms. This metric can be considered as a hardware agnostic measure of the temporal complexity. The deviation Δfₘᵢₙ from the global minima is also computed for every instance, where the exact solution is obtained via the brute-force method for n≤10.

ESPDP is an NP-hard problem. Therefore, there is no expectation of any exponential speedup here and the complexity of any heuristic algorithm must show the exponential scaling for a fixed amount of error tolerance, if n is sufficiently large. The power of a suitable heuristic algorithm, however, is to defer this exponential behavior above a certain threshold, where the problem size is large enough. For these numerical experiments, it is assumed that it is below that threshold and set the hyperparameters of the Perm-QIO tools (once for all instances and problem sizes), such that the temporal scaling, measured by the average number of queries to the cost function, scales linearly with n.

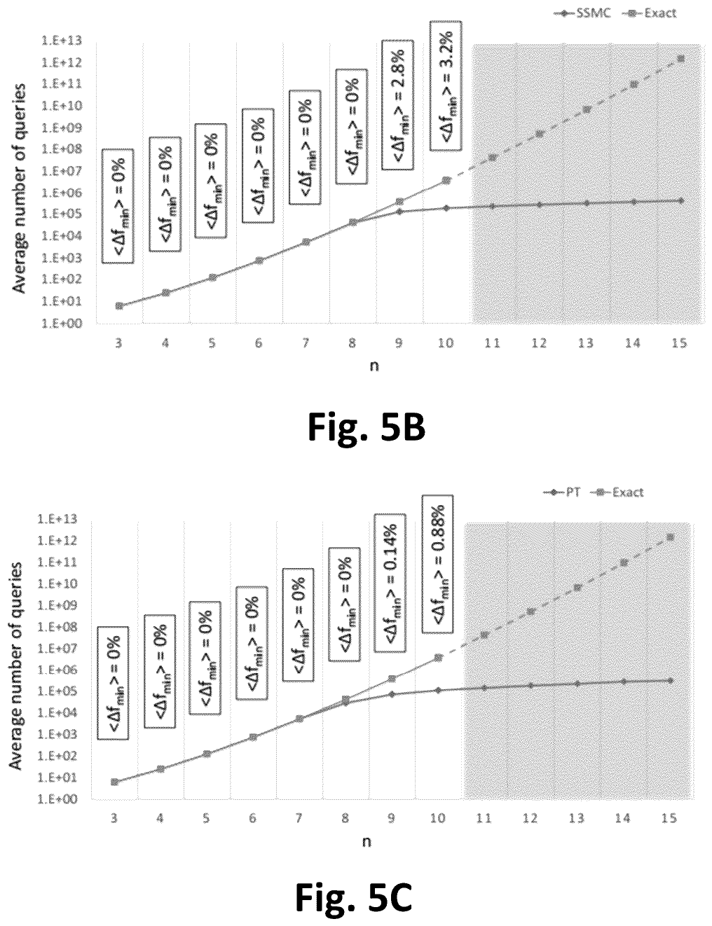

The graphs of FIGS. 5A, 5B, and 5C illustrate the average number of queries required to evaluate the objective function for an ESPDP having n stops using Perm-PA in FIG. 5A. Perm-SSMC in FIG. 5B, and Perm-PT in FIG. 5C. [symbol] Δfₘᵢₙ [symbol] denotes the deviation from the global minima averaged over all the problem instances for each n. [symbol] Δfₘᵢₙ [symbol] has been computed for n≤10, as the brute-force gets factorially more time-expensive as n increases.

Among all the Perm-QIO tools, Perm-PA continues to run until a final temperature is reached and all the replicas converge to the same solution corresponding to that temperature. Therefore, there is no precise control over the number of queries for Perm-PA.

However, the hyperparameters can be set such that the average number of queries scales approximately linearly with n, as shown in FIGS. 5A-5C, where the vertical axis is on log-scale. The hyperparameters of Perm-SSMC and Perm-PT are set such that the average number of queries is comparable with that for the Perm-PA. For all n≤10, the average deviation from the global minima is computed, denoted by [symbol] Δfₘᵢₙ [symbol] , where the global minima is calculated using the brute-force method that scales factorially with n. The results obtained from Perm-SSMC and Perm-PT are shown in FIG. 5B and 5C, respectively. The gray regions denote the regime for which there is no computation of the global minima using the brute-force method due to its expensive runtime for each problem instance.

The results demonstrate conspicuous efficacy of Perm-QIO techniques in solving a hard optimization problem over the space of permutations that is not even amenable to standard QIO. While Perm-SSMC and Perm-PT offer some room for improvement under appropriate hyperparameter tuning, the results obtained from Perm-PA show that on average it only explores ˜1.6% (=57208/10!) of the entire landscape of possible solutions for n =10 and yields an almost global minima, only differing from the true global minima by 0.043%. This result also indicates that the underlying landscape of the cost function contains some structure that can be leveraged by an optimization heuristic in order to obtain the solution more efficiently compared to a search algorithm.

As applied to ESPDP, a delivery vehicle may include the one or more vehicle computers to use a Perm-QIO technique for routing, or a central computer may be located at a dispatch center and use a Perm-QIO technique to supply an optimal route to the delivery vehicle.

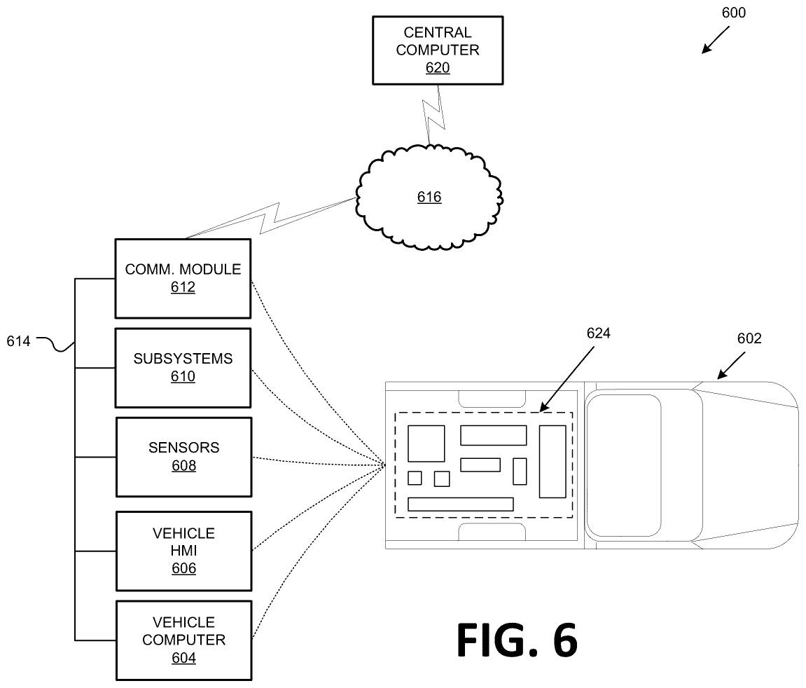

With reference to FIG. 6, a system 600 for a vehicular package delivery can provide communications between delivery vehicle 602 and a central computer 620 over a wireless link and/or wide area network 116 via a communication module 112 to provide package delivery services.

A delivery vehicle 602 (referred to hereinafter sometimes as vehicle 602 for brevity) is a set of components or parts, including hardware components and typically also software and/or programming, to perform a function or set of operations to operate the vehicle 602. Vehicle 602 includes a motive source such as an engine and/or battery/motor such as in an electric or hybrid vehicle for providing or assisting in propulsion of vehicle 602. Vehicle subsystems 610 include a fuel and/or battery subsystem, a braking system, a propulsion system, and a steering system as well as additional subsystems including but not limited to a navigation system, a climate control system, a lighting system, and an infotainment system. The fuel/ and/or battery subsystem will typically include a control module and will interface with the propulsion subsystem that converts energy to rotation of vehicle 102 wheels to propel the vehicle 102 forward and/or backward, and with possible regenerative portions of the braking subsystem that can slow and/or stop vehicle 102 movement. The steering subsystem can control a yaw, e.g., turning left and right, maintaining a straight path, of the vehicle 102 as it moves.

Computers, including the herein-discussed vehicle computer 604 and central computer 620, include respective processors and memories. A computer memory can include one or more forms of computer readable media, and stores instructions executable by a processor for performing various operations, including as disclosed herein. For example, the computer can be a generic computer with a processor and memory as described above and/or a vehicle computer 604, for example, may include an electronic control unit (ECU), controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., hard disk drives, solid state drives, servers, or any volatile or non-volatile media. The memory can store data, e.g., a memory of a vehicle computer 604 can store data sent from the fuel and/or battery subsystem 610. The memory can be a separate device from the computer, and the computer can retrieve information stored in the memory, e.g., a vehicle computer 604 can obtain data to be stored via a vehicle network 614 in the vehicle 602, e.g., over a CAN bus, a wireless network, etc. Alternatively, or additionally, the memory can be part of the computer, i.e., as a memory of the computer.

The vehicle computer 604 can be included in the vehicle 602 that may be any suitable type of ground vehicle 602 6, e.g., a passenger or commercial automobile such as a sedan, a coupe, a truck, a sport utility, a crossover, a van, a minivan, etc. used as a package delivery vehicle. A vehicle computer 604 may include programming to operate one or more of vehicle 602 brakes, propulsion (e.g., control of acceleration in the vehicle 602 by controlling one or more of an electric motor, hybrid engine, internal combustion engine, etc.), steering, climate control, interior and/or exterior lights, etc., as well as to determine whether and when the computer, as opposed to a human operator, is to control such operations. Additionally, a vehicle computer 604 may be programmed to determine whether and when a human operator is to control such operations.

A vehicle computer 604 may include or be communicatively coupled to, e.g., via a vehicle network 614 such as a communications bus as described further below, more than one processor, e.g., included in components such as subsystems 610, electronic controller units (ECUs) or the like included in the vehicle 602 for monitoring and/or controlling various vehicle components, e.g., a powertrain controller, a brake controller, a steering controller, etc. The computer is generally arranged for communications on a vehicle 602 communication network that can include a bus in the vehicle 602 such as a controller area network (CAN) or the like, and/or other wired and/or wireless mechanisms. Alternatively, or additionally, in cases where the computer actually comprises a plurality of devices, the vehicle 602 communication network may be used for communications between devices represented as the computer in this disclosure.

The vehicle network 614 is a network via which messages can be exchanged between various devices in vehicle 602. The vehicle computer 604 can be generally programmed to send and/or receive, via vehicle network 614, messages to and/or from other devices in vehicle 602 e.g., any or all of ECUs, sensors 608, actuators, components, communications module 612, a human machine interface HMI 606, etc. Additionally, or alternatively, messages can be exchanged among various such other devices in vehicle 602 via a vehicle network 614. In cases in which the computer includes a plurality of devices, vehicle network 614 may be used for communications between devices represented as a computer in this disclosure. Further, as mentioned below, various controllers and/or fuel/battery subsystem 610 may provide data to the computer 604. In some implementations, vehicle network 614 can be a network in which messages are conveyed via a vehicle 602 communications bus. For example, vehicle network 614 can include a controller area network (CAN) in which messages are conveyed via a CAN bus, or a local interconnect network (LIN) in which messages are conveyed via a LIN bus. In some implementations, vehicle network 614 can include a network in which messages are conveyed using other wired communication technologies and/or wireless communication technologies e.g., Ethernet, WiFi, Bluetooth, Ultra-Wide Band (UWB), etc. Additional examples of protocols that may be used for communications over vehicle network 614 in some implementations include, without limitation, Media Oriented System Transport (MOST), Time-Triggered Protocol TTP, and FlexRay. In some implementations, vehicle network 614 can represent a combination of multiple networks, possibly of different types, that support communications among devices in vehicle 602. For example, vehicle network 614 can include a CAN in which some devices in vehicle 602 communicate via a CAN bus, and a wired or wireless local area network in which some device in vehicle 602 communicate according to Ethernet or WI-FI communication protocols.

The vehicle computer 604 and/or central computer 620 can communicate via a wide area network 616. Further, various computing devices discussed herein may communicate with each other directly, e.g., via direct radio frequency communications according to protocols such as Bluetooth or the like. For example, a vehicle 602 can include a communication module 612 to provide communications with devices and/or networks not included as part of the vehicle 602, such as the wide area network 616, for example. The communication module 612 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle 602, to an infrastructure element typically via direct radio frequency communications and/or typically via the wide area network 616, e.g., to the central computer 620. The communication module 612 could include one or more mechanisms by which a vehicle computer 604 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, cellular V2X, CV2X, and the like.

The delivery vehicle 602 includes an area for storing and transporting a plurality of packages 624 to a plurality of delivery locations as part of system 600. Since it is possible that multiple packages 624 may be delivered to the same location, there may be more packages 624 than delivery locations for the packages 624. Additionally, as used herein, the term “package” is not limited to boxed or wrapped items for delivery, and may include other items subject to vehicular delivery, such as but not limited to floral arrangements, food deliveries, canned goods, building supplies, bottled water jugs, beer kegs, printed materials (e.g., stacks of newspapers), and other large items such as vehicles (cars, boats, motorcycles, mopeds, bicycles, etc).

In use, Perm-QIO operations may be performed on central computer 620 or may be performed on vehicle computer 604 with delivery location and package weight information supplied either from central computer 620 or via the vehicle HMI 606.

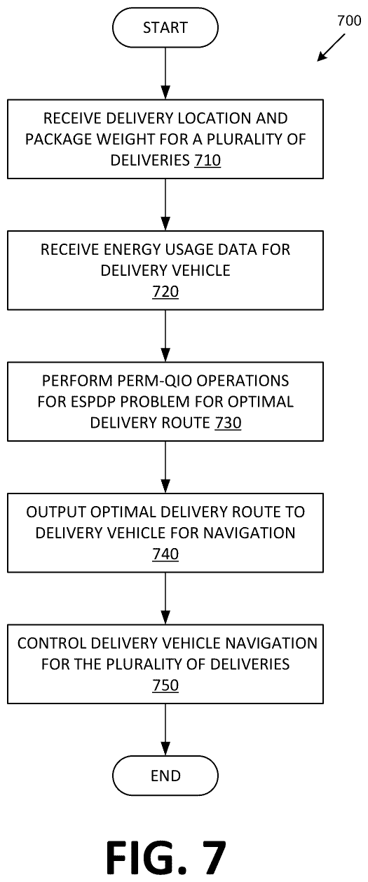

FIG. 7 is an example flow diagram of a process 700 of using Perm-QIO operations solve the ESPDP problem in order to optimize package delivery to a plurality of delivery locations.

In a first block 710, computer 604 or 620 receives a delivery location and an associated package(s) weight for a plurality of package deliveries.

In a next block 720, the computer 604 or 620 receives energy usage data of the particular delivery vehicle 602. For a diesel, gasoline, or hybrid vehicle, this may be a miles/gallon (MPG) curve that varies based upon the overall weight of the vehicle. For an electric vehicle, it may be a energy use measured as miles/kW curve that varies based upon the overall weight of the vehicle.

In block 730, computer 604 or 620 performs Perm-QIO operations to solve the ESPDP problem for the plurality of package deliveries. The Perm-QIO operations may be Perm-PA, Perm-PT, or Perm-SSMC.

In block 740, the computer 604 or 620 outputs the solution resulting from the Perm-QIO operations in the form of an optimal delivery route to delivery vehicle 602. When performed on computer 604, the output may be via vehicle network 614. When performed on central computer 620, the output may be to the wide area network 616 and communication module 612. For a driver-operated vehicle 602, the output may be delivered to a navigation subsystem of the vehicle 602 to display a delivery route on HMI 606. For an autonomous delivery vehicle 602, the output may be delivered to an autonomous driving subsystem.

In a next block 750, the output is used to control navigation of delivery vehicle 602 for the plurality of deliveries. In a driver-operated vehicle, this may be turn-by-turn audio-visual directions. In an autonomous vehicle, this may be actuation of the propulsion, braking, and steering subsystems.

As used herein, “cost” refers to a result of a cost-function.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a.” “the.” etc. should be read to recite one or more of the indicated elements unless a claim recites an explicit limitation to the contrary.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a computer including a processor and a memory, the memory storing instructions executable by the processor programmed to:
generate a set of random replicas for a permutation-based optimization problem having an objective function representing only an original unconstrained objective, wherein each replica is a sequence of n symbols;
define a neighborhood for each replica within a domain of the objective function; and
iteratively perform steps of an optimization algorithm to:
perform local operations with probabilistic acceptance criterion to transform a first replica to a second replica within a neighborhood of the first replica;
compare a least cost of the second replica to a previously stored overall minimum cost;
store the second replica as new overall minimum cost when the least cost of the second replica is less than the previously stored overall minimum cost; and
perform a next iteration until a convergence or a maximum number of iterations is achieved.

2. The system of claim 1, wherein the instructions to generate the set of random replicas includes instructions to generate the replicas sampled from a uniform distribution of permutations.

3. The system of claim 2, wherein the instructions to generate the set of random replicas using Durstenfeld's implementation for a Fisher-Yates algorithm.

4. The system of claim 1, wherein the local operations comprise a transposition of an adjacent pair of symbols.

5. The system of claim 4, wherein the adjacent pair of symbols are selected randomly.

6. The system of claim 1, wherein the optimizing algorithm is a Quantum-Inspired Optimization technique including Parallel Tempering.

7. The system of claim 6, further comprising instructions to:
initialize a temperature space from Tₘᵢₙ to Tₘₐₓ in accordance with a profile function with Tₙᵤₘ distinct temperatures;
initialize a random replica for each temperature in the temperature space;
initialize an overall minimum cost to infinity; and
initialize an iteration number to 0,
wherein each iteration further includes instructions to swap random neighboring replicas.

8. The system of claim 9, wherein the probabilistic acceptance criterion is a Metropolis acceptance criterion, and
the instructions to iteratively swap random neighboring replicas swaps random neighboring replicas with Metropolis acceptance criterion.

9. The system of claim 1 wherein the optimizing algorithm is a Quantum-Inspired Optimization technique including Population Annealing.

10. The system of claim 1 wherein the optimizing algorithm is a Quantum-Inspired Optimization technique including Substochastic Monte Carlo.

11. A method comprising:
generating a set of random replicas for a permutation-based optimization problem having an objective function representing only an original unconstrained objective, wherein each replica is a sequence of n symbols;
defining a neighborhood for each replica within a domain of the objective function; and
iteratively performing steps of an optimization algorithm to:
perform local operations with probabilistic acceptance criterion to transform a first replica to second replica within a neighborhood of the first replica;
compare a least cost of second replica to a previously stored overall minimum cost;
store the second replica as new overall minimum cost when the least cost is less than the previously stored overall minimum cost; and
perform a next iteration until a convergence or a maximum number of iterations is achieved.

12. The method of claim 11, wherein generating the set of random replicas includes generating the replicas sampled from a uniform distribution of permutations.

13. The method of claim 12, wherein generating the set of random replicas using Durstenfeld's implementation for a Fisher-Yates algorithm.

14. The method of claim 11, wherein the local operations comprises an adjacent transposition of an adjacent pair of symbols.

15. The method of claim 14, wherein the adjacent pair of symbols are selected randomly.

16. The method of claim 11 wherein the optimizing algorithm is a Quantum-Inspired Optimization technique including Parallel Tempering.

17. The method of claim 16, further comprising:
initializing a temperature space from Tₘᵢₙ to Tₘₐₓ in accordance with a profile function with Tₙᵤₘ distinct temperatures;
initializing a random replica for each temperature in the temperature space;
initializing an overall minimum cost to infinity; and
initializing an iteration number to 0, and
wherein each iteration further includes an operation to swap random neighboring replicas.

18. The method of claim 17, wherein the probabilistic acceptance criterion is a Metropolis acceptance criterion, and
the operation to swap random neighboring replicas swaps random neighboring replicas with Metropolis acceptance criterion.

19. The method of claim 11 wherein the optimizing algorithm is a Quantum-Inspired Optimization technique including Population Annealing.

20. The method of claim 11 wherein the optimizing algorithm is a Quantum-Inspired Optimization technique including Substochastic Monte Carlo.
